(19) United States
(12) Patent Application Publication
(10) Pub. No.: US 2015/0198405 A1
(43) Pub. Date: Jul. 16, 2015

(54) BARREL NUT WRENCH FOR FIREARMS

(71) Applicant: Multitasker Tools LLC, Marietta, GA (US)

(72) Inventor: Shane Keng, Marietta, GA (US)

(21) Appl. No.: 14/594,498

(22) Filed: Jan. 12, 2015

Related U.S. Application Data
(60) Provisional application No. 61/926,463, filed on Jan. 13, 2014.

(51) Int. Cl. F41A 35/00; F41A 21/48; B25B 13/48; F41A 11/00

(52) U.S. Cl. CPC F41A 35/00; F41A 11/00; F41A 21/48; B25B 13/48

(57) ABSTRACT

A barrel nut wrench is disclosed. The barrel nut wrench may include a handle portion and a head portion. The head portion may include a first side and a second side. The first side of the head portion may include a plurality of holes. At least one removable contact lug may be positionable within at least one of the plurality of holes.

### CROSS-REFERENCE TO RELATED APPLICATIONS

The disclosure claims priority to and the benefit of U.S. provisional patent application No. 61/926,463, filed Jan. 13, 2014, which is herein incorporated by reference in its entirety.

### FIELD OF THE DISCLOSURE

The disclosure generally relates to firearms and more particularly relates to a barrel nut wrench for engagement with a barrel nut of a firearm.

### BACKGROUND

In many modern rifles, the barrel is not permanently affixed to the receiver. In this manner, the barrel can be replaced when necessary. For example, a chamber end of the barrel may be threaded to the receiver. Proper installation of the barrel usually comprises tightening a threaded lock nut (i.e., a barrel nut) to prevent the assembly from coming loose. Not all barrel nuts, however, are the same. That is, various firearms may have different barrel nuts, resulting in a number of designs and configurations. Accordingly, may different tools (such as barrel nut wrenches) may be needed to tighten (or loosen) a variety of different barrel nuts.

### SUMMARY

Some or all of the above needs and/or problems may be addressed by certain embodiments of the barrel nut wrench disclosed herein. According to an embodiment, the barrel nut wrench may include a handle portion and a head portion. The head portion may include a first side and a second side. The first side of the head portion may include a plurality of holes. At least one removable contact lug may be positionable within at least one of the plurality of holes.

Other features and aspects of the barrel nut wrench will be apparent or will become apparent to one with skill in the art upon examination of the following figures and the detailed description. All other features and aspects, as well as other system, method, and assembly embodiments, are intended to be included within the description and are intended to be within the scope of the accompanying claims.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts a barrel nut wrench in accordance with one or more embodiments of the disclosure.

FIG. 2 schematically depicts a barrel nut wrench in accordance with one or more embodiments of the disclosure.

FIG. 3 schematically depicts a barrel nut wrench in accordance with one or more embodiments of the disclosure.

FIG. 4 schematically depicts a barrel nut wrench coupled to a barrel nut of a firearm in accordance with one or more embodiments of the disclosure.

FIG. 5 schematically depicts a barrel nut wrench coupled to a barrel nut of a firearm in accordance with one or more embodiments of the disclosure.

FIG. 6 schematically depicts a barrel nut wrench coupled to a barrel nut of a firearm in accordance with one or more embodiments of the disclosure.

### DETAILED DESCRIPTION

Described below are embodiments of a barrel nut wrench that can be used as a tool to tighten and/or loosen a barrel nut of a firearm. The firearm may be a conventional firearm. For example, the firearm may be an M-16 style rifle, an AR-15 style rifle, an AR-10 style rifle, or an M-4 style rifle, among others. The barrel nut wrench may be used with any type of rifle having a barrel nut or the like.

Generally speaking, the barrel nut wrench may include a handle portion and a head portion. The handle portion may be configured to be grasped by a user. The handle portion may be spaced apart a suitable distance from the head portion to provide adequate torque. In certain embodiments, the handle portion and the head portion may be integrally formed. That is, the handle portion and the head portion may be part of the same unitary body but at opposite ends thereof.

In some instances, the head portion may be crescent shaped (e.g., C-shaped). The head portion may be any shape or configuration. The head portion may include a first side and an opposing second side. The first side of the head portion may include a plurality of holes. The holes may be equally spaced apart or having varying distances therebetween. In some instances, the holes may be threaded holes.

At least one removable contact lug may be positioned within at least one of the holes. For example, the at least one removable contact lug may be threaded into at least one of the holes. In this manner, the at least one removable contact lug may include corresponding threads on at least one end thereof. For example, the at least one removable contact lug may be a set screw or the like. When positioned within at least one of the holes, the at least one removable contact lug may extend a suitable distance beyond the first side of the head portion to enable engagement of the at least one removable contact lug with a barrel nut. For example, the at least one removable contact lug may be configured to mate with a corresponding slot or the like in the barrel nut.

In certain embodiments, the at least one removable contact lug may comprise a plurality of removable contact lugs. The removable contact lugs may be position within two or more of the holes in a pattern specific to a particular barrel nut. In this manner, the removable contact lugs may be arranged (e.g. customized) in a variety of patterns to loosen or tighten a number of different barrel nuts for a number of different firearms. That is, any number of removable contact lugs may be positioned within two or more of the holes to accommodate a specific barrel nut configuration. In this manner, the barrel nut wrench may be customized to a number of barrel nuts.

The second side of the head portion may include a plurality of semicircular contact lugs. In some instances, the semicircular contact lugs may be arranged in a C-shape that corresponds to the shape of the head portion. In some instances, the semicircular contact lugs may be omitted.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

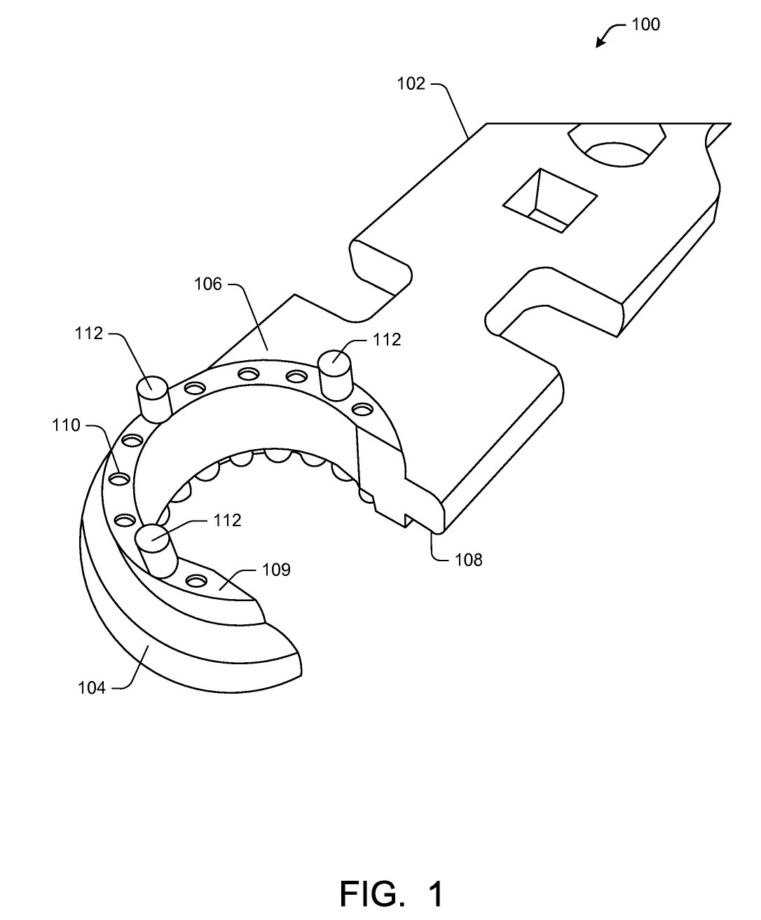

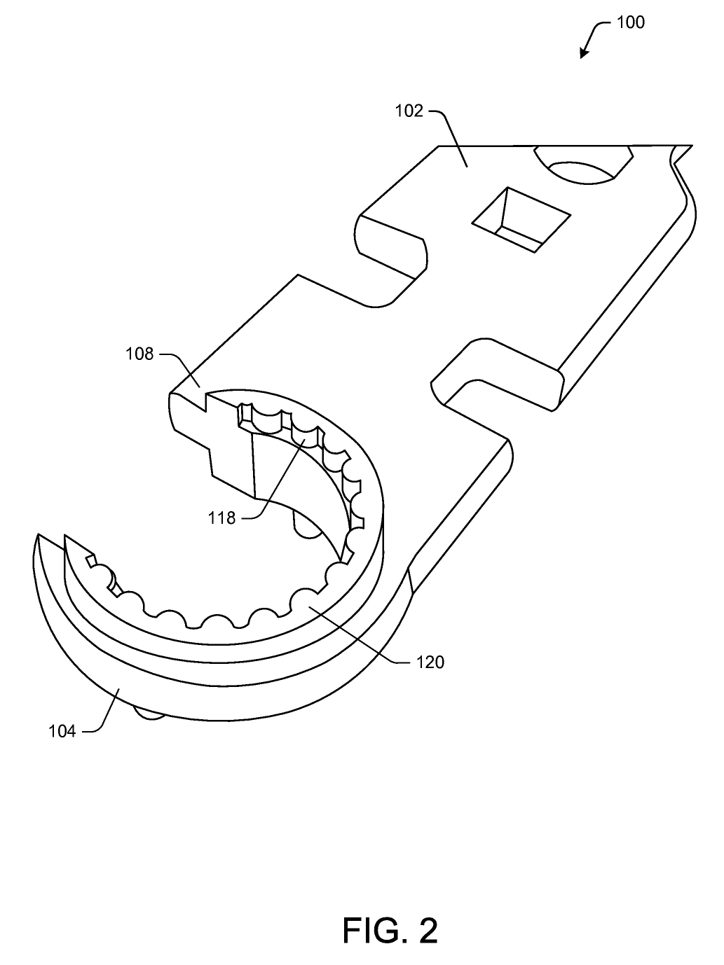

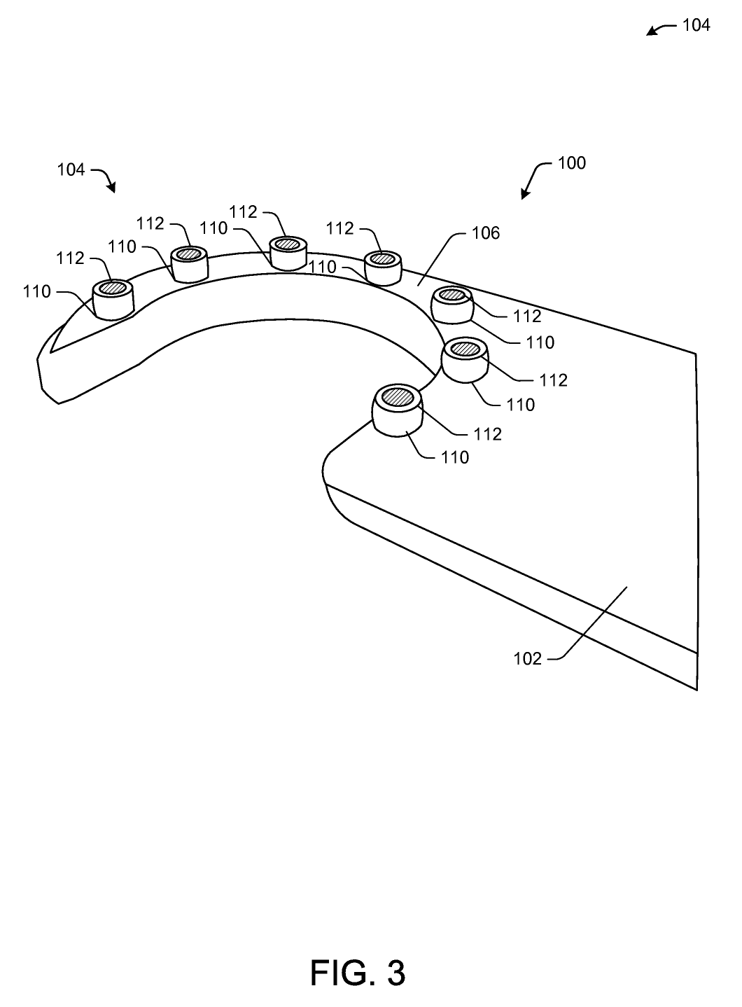

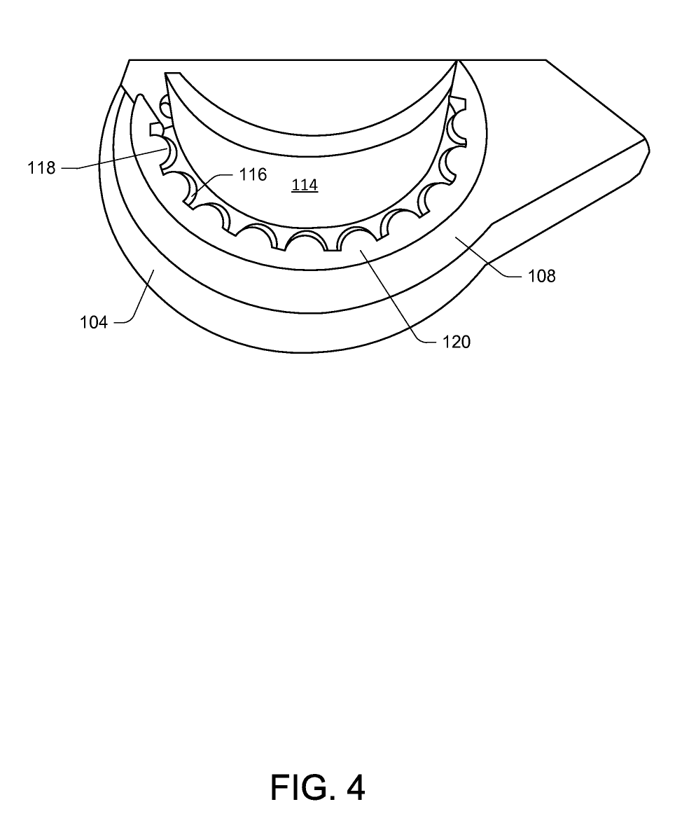

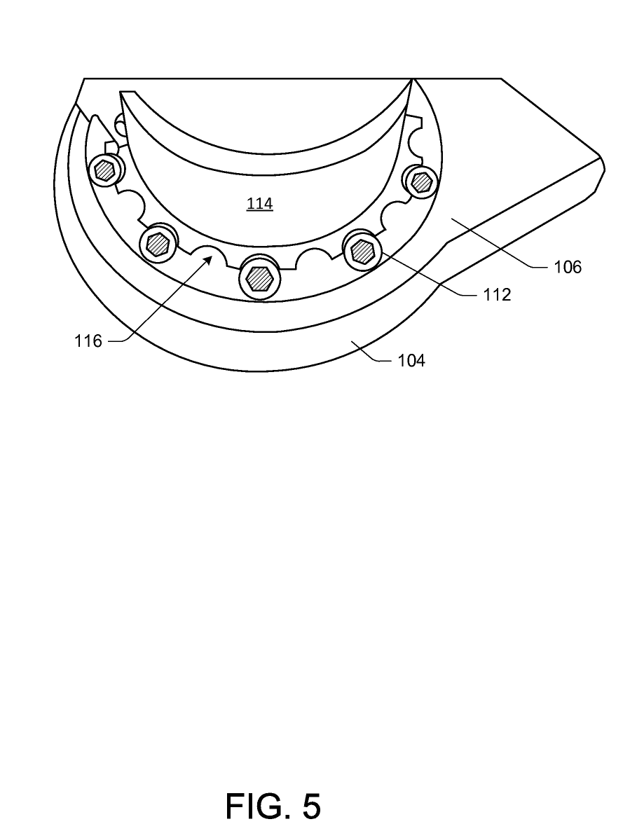

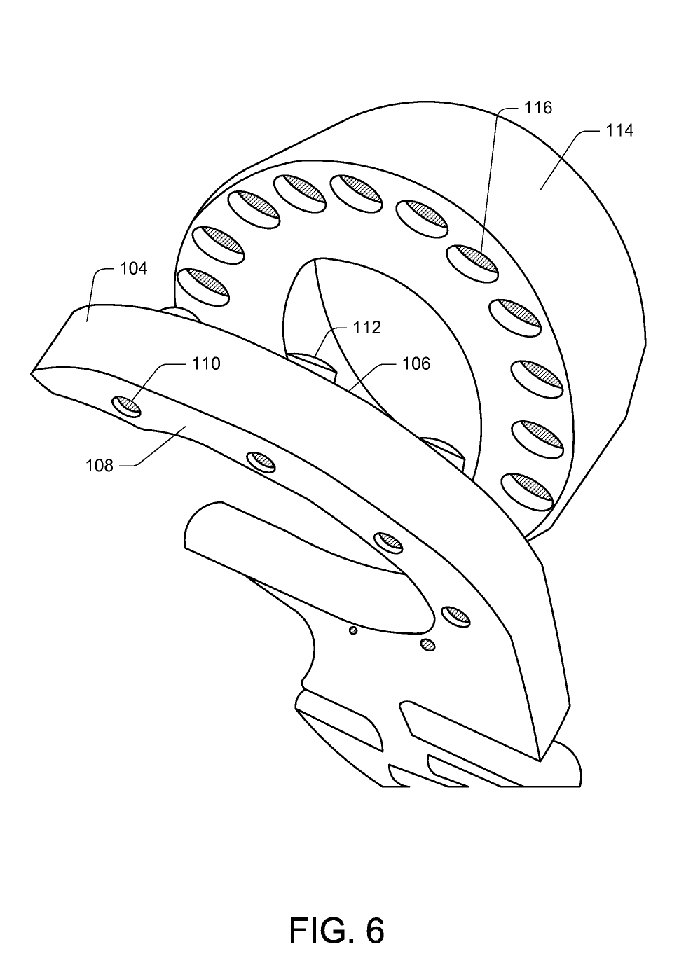

FIGS. 1-6 schematically depict a barrel nut wrench 100. The barrel nut wrench 100 may be used to tighten and/or loosen a barrel nut of a firearm, such as an M-16 style rifle, an AR-15 style rifle, an AR-10 style rifle, or an M-4 style rifle, among others. The barrel nut wrench 100 may be used with any type of rifle.

The barrel nut wrench 100 may include a handle portion 102 and a head portion 104. The handle portion 102 may be configured to be grasped by a user. In some instances, the handle portion 102 may include an enhanced gripping surface. The handle portion 102 may be any suitable shape. The handle portion 102 may be spaced apart a suitable distance from the head portion 104 to provide adequate torque. In certain embodiments, the handle portion 102 and the head portion 104 may be integrally formed. That is, the handle portion 102 and the head portion 104 may be part of the same unitary body but at opposite ends thereof.

In some instances, the head portion 104 may be crescent shaped (e.g., C-shaped). The head portion 104 may be any shape or configuration. The head portion 104 may include a first side 106 and a second side 108. The first side 106 of the head portion 104 may include a plurality of holes 110. The holes 110 may be equally spaced apart or having varying distances therebetween. In some instances, the holes 110 may be threaded holes. The head portion 104 may include any number of holes 110. In some instances, the holes 110 may be arranged in a full or partial circle. The holes 110 may be arranged in any suitable pattern. In some instances, the first side 106 may include a raised lip 109. In such instances, the holes 110 may be disposed within the raised lip 109. In other instances, the raised lip 109 may be omitted.

At least one removable contact lug 112 may be positioned within at least one of the holes 110. For example, the at least one removable contact lug 112 may be threaded into at least one of the holes 110. In this manner, the at least one removable contact lug 112 may include corresponding threads on at least one end thereof. For example, the at least one removable contact lug 112 may be a set screw or the like. In some instances, the at least one removable contact lug 112 may include a number of lugs positioned at the 3, 9, and 12 o'clock positions. When positioned within at least one of the holes 110, the at least one removable contact lug 112 may extend beyond the first side 106 of the head portion 104 to enable engagement of the at least one removable contact lug 112 with a barrel nut 114. For example, the at least one removable contact lug 112 may be configured to mate with a corresponding slot 116 (or hole) in the barrel nut 114.

In certain embodiments, the at least one removable contact lug 112 may comprise a plurality of removable contact lugs 112. The removable contact lugs 112 may be position within two or more of the holes 110 in a pattern specific to a particular barrel nut. The removable contact lugs 112 may be positioned in all or some of the holes 110. In this manner, the removable contact lugs 112 may be arranged (e.g. customized) in a variety of patterns to loosen or tighten a number of different barrel nuts for a number of different firearms. That is, any number of removable contact lugs 112 may be positioned within two or more of the holes 110 to accommodate a specific barrel nut configuration. In this manner, the barrel nut wrench 100 may be customized to a number of barrel nuts.

The second side 108 of the head portion 104 may include a plurality of semicircular contact lugs 118. In some instances, the semicircular contact lugs 118 may be arranged in a C-shape that corresponds to the shape of the head portion 104. The semicircular contact lugs 118 may be arranged in any suitable pattern. The semicircular contact lugs 118 may be configured to mate with a corresponding slot 116 or the like in the barrel nut 114. In some instances, the semicircular contact lugs 118 may be omitted. The second side 108 may include a raised lip 120. In such instances, the semicircular contact lugs 118 may be disposed within the raised lip 120. In other instances, the raised lip 120 may be omitted.

It is an advantage of the present disclosure that the removable contact lugs 112 can be replaced. For example, the removable contact lugs 112 can be replaced if they get worn or damaged. It is an additional advantage of the present disclosure that a number of the removable contact lugs 112 may be inserted into the holes 110 to provide greater contact surface with a barrel nut, allowing for more secure engagement than a typical 3-lug arrangement. It is also an advantage of the present disclosure that the threaded holes 110 allow for the mounting of customized pattern barrel nut wrenches.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A barrel nut wrench for engagement with a barrel nut of a firearm, the barrel nut wrench comprising:
a handle portion; and
a head portion comprising a first side and a second side, wherein the first side of the head portion comprises:
a plurality of holes; and
at least one removable contact lug positionable within at least one of the plurality of holes.

2. The barrel nut wrench of claim 1, wherein the at least one removable contact lug is threadable into at least one of the plurality of holes.

3. The barrel nut wrench of claim 2, wherein the at least one removable contact lug comprises at least one set screw.

4. The barrel nut wrench of claim 1, wherein the at least one removable contact lug comprises a plurality of removable contact lugs.

5. The barrel nut wrench of claim 4, wherein the plurality of removable contact lugs are positionable within two or more of the plurality of holes in a pattern specific to a particular barrel nut.

6. The barrel nut wrench of claim 1, wherein the second side of the head portion comprises a plurality of semicircular contact lugs.

7. The barrel nut wrench of claim 1, wherein the head portion is C-shaped.

8. A barrel nut wrench, comprising:
a handle portion; and
a head portion comprising a first side and a second side, wherein the first side of the head portion comprises:
a plurality of holes; and
at least one removable contact lug positionable within at least one of the plurality of holes, wherein the at least one removable contact lug extends beyond the first side of the head portion when positioned within at least one of the plurality of holes for engagement with a barrel nut of a firearm.

9. The barrel nut wrench of claim 8, wherein the at least one removable contact lug is threadable into at least one of the plurality of holes.

10. The barrel nut wrench of claim 9, wherein the at least one removable contact lug comprises at least one set screw.

11. The barrel nut wrench of claim 8, wherein the at least one removable contact lug comprises a plurality of removable contact lugs.

12. The barrel nut wrench of claim 11, wherein the plurality of removable contact lugs are positionable within two or more of the plurality of holes in a pattern specific to a particular barrel nut.

13. The barrel nut wrench of claim 8, wherein the second side of the head portion comprises a plurality of semicircular contact lugs.

14. The barrel nut wrench of claim 8, wherein the head portion is C-shaped.

15. A barrel nut wrench for engagement with a barrel nut of a firearm, the barrel nut wrench comprising:
a handle portion; and
a C-shaped head portion comprising a first side and a second side, wherein the first side of the C-shaped head portion comprises a plurality of holes configured to receive at least one removable contact lug.

16. The barrel nut wrench of claim 15, wherein the at least one removable contact lug is threadable into at least one of the plurality of holes and extends beyond the first side of the C-shaped head portion for engagement with the barrel nut.

17. The barrel nut wrench of claim 16, wherein the at least one removable contact lug comprises at least one set screw.

18. The barrel nut wrench of claim 15, wherein the at least one removable contact lug comprises a plurality of removable contact lugs.

19. The barrel nut wrench of claim 18, wherein the plurality of removable contact lugs are positionable within two or more of the plurality of holes in a pattern specific to a particular barrel nut.

20. The barrel nut wrench of claim 15, wherein the second side of the head portion comprises a plurality of semicircular contact lugs.
